(19) United States
(12) Patent Application Publication
(10) Pub. No.: US 2005/0053041 A1
(43) Pub. Date: Mar. 10, 2005

(54) Apparatus and method for downlink channelization code allocation in UMTS

(76) Inventor: Mi-Ok Cheong, Gyeyang-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/936,661

(22) Filed: Sep. 9, 2004

(30) Foreign Application Priority Data
Sep. 9, 2003 (KR) 2003-63297

(51) Int. Cl. H04B 7/216

(52) U.S. Cl. 370/335

(57) ABSTRACT

Disclosed is a method for assigning orthogonal codes for channelization for data transmission by a radio network controller of a mobile communication system having an orthogonal code tree structure in which each of multiple upper codes having orthogonality between the upper codes is branched out into multiple lower codes which do not have orthogonality with respect to the upper codes, which comprising the steps of: a) confirming whether or not the lower codes derived from one upper code have different available states; and b) reassigning the orthogonal codes for the data transmission so that the lower codes derived from one upper code have same available states, when there exist two or more lower codes having the different available states as a result of the confirmation.

### PRIORITY

This application claims priority to an application entitled “Apparatus and method for downlink channelization code allocation in UMTS” filed in the Korean Intellectual Property Office on Sep. 9, 2003 and assigned Serial No. 2003-63297, the contents of which are hereby incorporated by reference.

### BACKGROUND OF THE INVENTION

1. Field of the Invention

The present invention relates to a universal mobile terrestrial system (‘UMTS’), and more particularly to an apparatus and a method for allocating an orthogonal variable spreading factor (‘OVSF’) code used in channelization.

2. Description of the Related Art

Code division multiple access (‘CDMA’) communication systems use orthogonal codes for channelization and the CDMA scheme includes a synchronous scheme and a asynchronous scheme. Hereinafter, description will be given on embodiments in which the present invention is realized in a wideband code division multiple access (‘W-CDMA’) communication system and a UMTS, which are the next generation mobile communication system and employ a asynchronous scheme. However, it is noted that the scope of the present invention is not limited to the W-CDMA and the present invention can be applied to other CDMA systems such as CDMA 2000 systems. Hereinafter, operations for allocating channels with orthogonal codes in the W-CDMA system will be described.

FIG. 1 is a block diagram showing a structure of a W-CDMA communication system.

As shown in FIG. 1, a radio network controller (‘RNC’) takes charge of all process regarding the connection of a certain user equipment (‘UE’). Further, the RNC controlling a node B also takes charge of resource allocation for each UE connected to the node B.

Herein, when a certain UE uses a common packet channel (‘CPCH’) or a random access channel (‘RACH’), which is a common channel, in order to connect to a specific node B, the RNC provides the UE and the node B with information on uplink channel resources (i.e., uplink scrambling code and OVSF code) for an available CPCH or RACH. The OVSF code is an orthogonal code and has the same function as that of a walsh code used in a CDMA 2000. In particular, the RNC provides the node B with available OVSF code node set information.

When successfully connecting to the node B in this way, the UE continues communication with the node B by means of a downlink or an uplink dedicated physical channel (‘DPCH’). In the W-CDMA system, the channels use a asynchronous scheme which does not accomplish synchronization with node B. Herein, one UE must receive its own inherent scrambling code so that the node B can distinguish the UE from other UEs.

Therefore, an uplink synchronous transmission scheme (‘USTS’) has been proposed. When the USTS is used, one scrambling code is assigned to multiple UEs, thereby enabling communication. In a method of using the USTS, synchronization is accomplished when the uplink DPCHs of the multiple UEs are received in a node B, thereby enabling one scrambling code to be assigned to the multiple UEs. Therefore, the number of scrambling codes assigned in one cell is reduced, thereby reducing mutual interference between signals of the multiple UEs. The node B distinguishes the multiple UEs using the USTS from each other by means of channelization codes provided from an RNC, that is OVSF codes having orthogonality between themselves. For convenience of description, the set of multiple UEs receiving and using one scrambling code is defined as an USTS group.

A stage obtaining uplink synchronization by means of the USTS scheme is classified into two steps and each step will be described hereinafter. A first step is an initial synchronization process. A node B receives the signal of a UE through a RACH and measures time difference between a preset reference time and a reception time at which the node B has received the signal of the UE through the RACH. Further, the node B transmits the time difference between the reception time and the reference time to the UE through a forward access channel (‘FACH’). The UE having received the time difference through the FACH adjusts a transmission time with the time difference and obtains an initial synchronization.

A second step is a tracking process. The node B periodically compares the reception time of the UE signal and the reference time and transmits a time alignment bit to the UE through the transmit power control (‘TPC’) bit of a control channel. Since the time alignment bit is transmitted through the TPC bit of the control channel, the time alignment bit is transmitted once for every two frames. The time alignment bit may adjust a transmission time by the n chip. In a case in which the time alignment bit adjusts the transmission time by the ⅛ chip, when the time alignment bit has a value of 1, the UE advances the transmission time by the ⅛ chip. In contrast, when the time alignment bit has a value of 0, the UE delays the transmission time by the ⅛ chip.

Hereinafter, an orthogonal code (i.e., OVSF code) for channelization currently used in a W-CDMA communication system will be described with reference to FIG. 2.

In a case of downlink transmission, channels may be distinguished from each other by the OVSF code and the channels may have different data rates. In contrast, in a case of uplink transmission, channels in one UE are distinguished from each other. Further, in a case of USTS in which UEs use the same scrambling codes, channels of each UE are distinguished from each other. The OVSF code Cn,k is uniquely determined according to a spreading factor (‘SF’) and code number k. In the OVSF code, n represents an SF value and k has a value of 0≦k≦SF−1. The OVSF code is generated by equation 1.

$${C}_{1 , 0} = 1 , \\ [ \begin{matrix}{C}_{2 , 0} \\ {C}_{2 , 1}\end{matrix} ] = [ \begin{matrix}{C}_{1 , 0} & {C}_{1 , 0} \\ {C}_{1 , 0} & - {C}_{1 , 0}\end{matrix} ] = [ \begin{matrix}1 & 1 \\ 1 & - 1\end{matrix} ] \\ [ \begin{matrix} {C}_{{2}^{( n + 1 )} , 0} \\ {C}_{{2}^{( n + 1 )} , 1} \\ {C}_{{2}^{( n + 1 )} , 2} \\ {C}_{{2}^{( n + 1 )} , 3} \\ ⋮ \\ {C}_{{2}^{( n + 1 )} , {2}^{( n + 1 )} - 2} \\ {C}_{{2}^{( n + 1 )} , {2}^{( n + 1 )} - 1}\end{matrix} ] = [ \begin{matrix} {C}_{{2}^{n} , 0} & {C}_{{2}^{n} , 0} \\ {C}_{{2}^{n} , 0} & - {C}_{{2}^{n} , 0} \\ {C}_{{2}^{n} , 1} & {C}_{{2}^{n} , 1} \\ {C}_{{2}^{n} , 1} & - {C}_{{2}^{n} , 1} \\ ⋮ & \\ {C}_{{2}^{n} , {2}^{n} - 1} & {C}_{{2}^{n} , {2}^{n} - 1} \\ {C}_{{2}^{n} , {2}^{n} - 1} & - {C}_{{2}^{n} , {2}^{n} - 1}\end{matrix} ] \qquad Equation 1$$

The OVSF code from SF=1 to SF=4 generated by equation 1 may be expressed by equation 2.
C1,2=(1)
C2,0=(1,1)
C2,1=(1,−1)
C4,0=(1,1,1,1)
C4,2=(1,−1,1,−1)
C4,3=(1,−1,−1,1) Equation 2

FIG. 2 shows the OVSF code-tree. Hereinafter, in the detailed description of the present invention, the Cn,k in the OVSF code-tree is expressed by a node. For instance, an OVSF code C1,0 is expressed by a node C1,0 or C1,0 node in an OVSF code-tree.

The characteristics of the OVSF code will be described with reference to FIG. 2. Child-nodes corresponding to a mother-node do not maintain orthogonality with the mother-node. For instance, in a case in which a node C4,0 has been assigned to a specific channel, when another channel is assigned to all mother-nodes C2,0 and C1,0 corresponding to the node C4,0 and all child-nodes or sub-nodes C8,0, C8,1, C16,0, C16,1, C16,2, C16,3, etc., on the basis of the node C4,0 as shown in the OVSF code-tree, orthogonality cannot be maintained. In the below description, a sub-tree represents all child-nodes of a specific node. That is, when C4,0=(1,1,1,1) in equation 2 has been assigned to a specific channel, orthogonality does not exist between C2,0=(1,1) and C8,0=(1,1,1,1,1,1,1,1)/C8,1=(1,1,1,1,−1,−1,−1,−1). Accordingly, when the OVSF code is assigned to channels having different SF values (data rates), the OVSF code must be assigned so that orthogonality can be maintained with the assigned OVSF code.

As described above, when the OVSF code is randomly assigned due to the structural characteristics of the OVSF code-tree, the number of unavailable codes (are not actually used) increases. Therefore, even though many other radio resources actually exist, a mobile communication service may be limited due to the shortage of the OVSF code. Accordingly, a method for solving the aforementioned problem is required.

### SUMMARY OF THE INVENTION

Accordingly, the present invention has been made to solve the above-mentioned problems occurring in the prior art, and it is an object of the present invention is to provide an apparatus and a method for effectively assigning limited OVSF codes for downlink channelization.

It is another object of the present invention is to provide an apparatus and a method for minimizing the number of unavailable OVSF codes generated by using a specific OVSF code.

It is further another object of the present invention is to provide an apparatus and a method for effectively using radio sources by minimizing the number of unavailable OVSF codes.

In order to accomplish the aforementioned object, according to one aspect of the present, there is provided a method for assigning orthogonal codes for channelization for data transmission by a radio network controller of a mobile communication system having an orthogonal code tree structure in which each of multiple upper codes having orthogonality between the upper codes is branched out into multiple lower codes which do not have orthogonality with respect to the upper codes, the method comprising the steps of: a) confirming whether or not the lower codes derived from one upper code have different available states; and b) reassigning the orthogonal codes for the data transmission so that the lower codes derived from one upper code have same available states, when there exist two or more lower codes having the different available states as a result of the confirmation.

In order to accomplish the aforementioned object, according to one aspect of the present, there is provided an apparatus for assigning orthogonal codes for channelization for data transmission in a mobile communication system having an orthogonal code tree structure in which each of multiple upper codes having orthogonality between the upper codes is branched out into multiple lower codes which do not have orthogonality with respect to the upper codes, the apparatus comprising: a radio network controller for confirming whether or not the lower codes derived from one upper code have different available states, and reassigning the orthogonal codes for the data transmission so that the lower codes derived from one upper code have same available states, when there exist two or more lower codes having the different available states as a result of the confirmation; and a node B and a user equipment for setting a radio channel by means of the orthogonal codes assigned by the radio network controller and exchanging data through the set radio channel.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a structure of a W-CDMA communication system;

FIG. 2 is a view showing an OVSF code tree used in a W-CDMA communication system;

FIG. 3 is a flowdiagram illustrating a method by which a RNC relocates an OVSF code according to the present invention;

FIG. 4 is a view showing a structure of an OVSF code tree satisfying a condition for relocating an OVSF code according to the present invention;

FIG. 5 is a view illustrating a result obtained by relocating the code tree of FIG. 4; and

FIG. 6 is a flowdiagram illustrating a process by which an RNC transmits information on the relocated OVSF code tree according to the present invention.

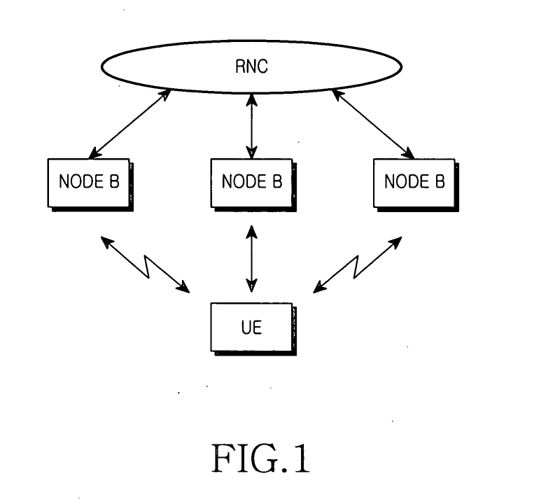

### DETAILED DESCRIPTION OF THE PREFERRED EMBODIMENT

Hereinafter, a preferred embodiment according to the present invention will be described with reference to the accompanying drawings. In the following description of the present invention, a detailed description of known functions and configurations incorporated herein will be omitted when it may make the subject matter of the present invention rather unclear.

—Kind of Relocation—

The present invention relates to a method for rearranging assigned OVSF codes by an assigned degree of density. First, the present invention includes the following states according to whether or not an OVSF code is used:
IDLE: represents an unassigned OVSF code state;
USE: represents an assigned OVSF code state; and
BLOCK: represents a state in which an OVSF code cannot be assigned according to the characteristics of an OVSF code-tree even though the OVSF code has not been assigned.

The method relocating the OVSF codes may be classified into a scheme relocating the OVSF codes according to a preset period and a scheme relocating the OVSF codes when a preset condition is satisfied. Table 1 shows one example of a process performing the scheme periodically relocating the OVSF codes and the scheme automatically relocating the OVSF codes.

TABLE 1

| | Performance or non- | | Performance or non- |
|---|---|---|---|
| | performance of | Relocation | performance of |
| SF | periodical relocation | performance period | automatic relocation |
| 4 | OFF | time_SF4 | OFF |
| 8 | ON | time_SF8 | ON |
| 16 | ON | time_SF16 | ON |
| 32 | ON | time_SF32 | ON |
| 64 | ON | time_SF64 | ON |
| 128 | ON | time_SF128 | ON |
| 256 | ON | time_SF256 | OFF |
| 512 | OFF | time_SF512 | OFF |

The periodical relocation scheme and the automatic relocation scheme will be described with reference to table 1. Table 1 includes SF4, SF8, SF16, SF32, SF64, SF128, SF256, and SF512 and each SF has items regarding performance or non-performance of periodical relocation, a relocation performance period and performance or non-performance of automatic relocation. The performance or non-performance of the periodical relocation is an item regarding whether to relocate the OVSF codes by the preset period or not, and the relocation performance period is an item representing a period by which the OVSF codes are relocated when the periodical relocation is performed. Herein, the relocation performance period can be set at a constant value regardless of the performance or non-performance of the periodical relocation. The performance or non-performance of the periodical relocation may change by the selection of a user. Herein, the relocation performance period is set regardless of the performance or non-performance of the periodical relocation in order to eliminate inconvenience due to resetting of the relocation performance period whenever the performance or non-performance of the periodical relocation changes. The performance or non-performance of the automatic relocation is an item representing whether to relocate the OVSF codes or not when a preset condition is satisfied. Hereinafter, the preset condition in the automatic relocation will be described.

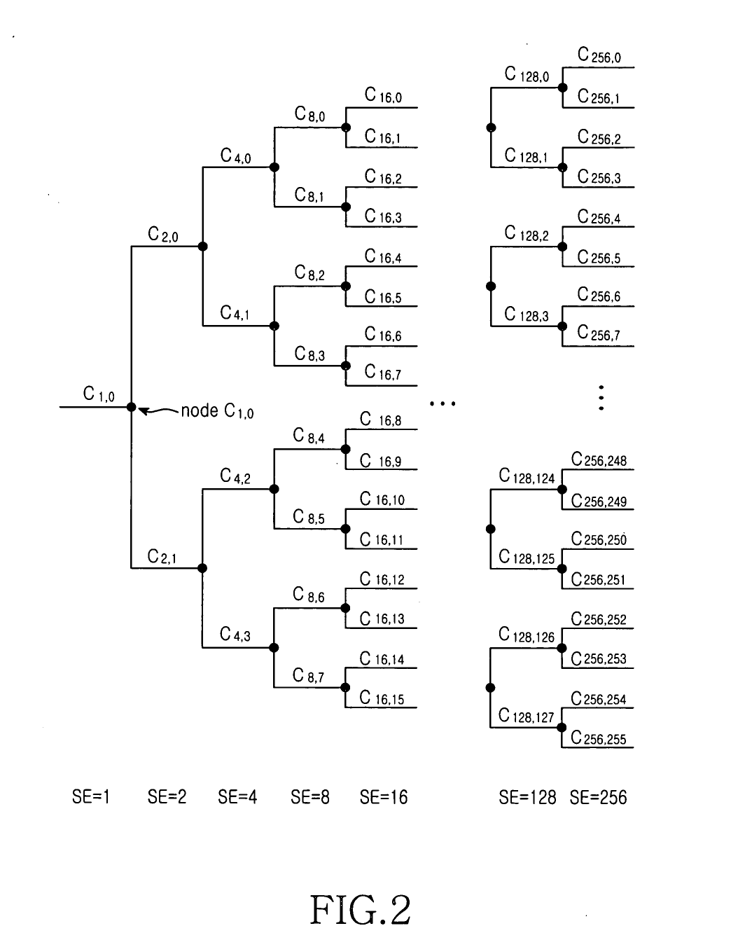

The preset condition of the automatic relocation in relation to the present invention relates to the SF4 in FIG. 2. The SF4 includes four SFs and the four SFs are as follows:
C4,0=(1,1,1,1);
C4,1=(1,1,−1,−1);
C4,2=(1,−1,1,−1); and
C4,3=(1,−1,−1,1).

The preset condition is a case in which the four SFs are being used or cannot be used by a mother-node and a child-node. However, the SF4, which is a preset condition, can be randomly selected by a user. Besides the SF4, an SF8, an SF16, etc., can be set by the user. Hereinafter, the SF4 will be described. One reason for the preset condition to be set for the use of the four SFs is that an SF is assigned or not assigned when one to three SFs are being used. The waste of resources due to the performance of the relocation algorithm can thus be prevented. Additionally, a time at which the assigned code is released is a time performing the relocation. When one channel has not been released before the code relocation is completed, there is a point at which simultaneously the code exists before the relocation and after the relocation.

—SF Determination Method for Relocation Performance—

In the periodical relocation scheme, a relocation for a corresponding SF is performed according to a preset period. That is, a ratio toggled according to each SF is measured and a relocation is performed for an SF having the highest toggling ratio. The toggle represents a case in which one pair of codes have different use state values. When one pair of codes cannot be used or are being used, the toggle has a value of 0. In contrast, when only one of one pair of codes can be used, the toggle has a value of 1. A detailed example about the toggle will be described below. The value of a toggle for a corresponding SF is measured whenever a specific event occurs. Accordingly, an RNC always recognizes the value of the toggle for the corresponding SF. The RNC determines an SF for which a relocation is to be performed by the toggling ratio of a corresponding SF recognized by the RNC when the automatic relocation condition or the preset condition passes.

—Factor for Performing Relocation—

Hereinafter, each SF of the SF4 will be called one group. In order to perform the relocation, values of factors shown in the following table 2 are obtained.

TABLE 2

| | |
|---|---|
| alloc factor | The number of codes which are blocks and USEs in a group |
| block factor | The number of codes which are blocks in a group |
| toggle factor | The number of toggles in a group |

Table 2 includes values which must be obtained for a corresponding SF for which a relocation is to be performed. Accordingly, when an OVSF code is assigned or released in order to obtain the values corresponding to the factors, the values corresponding a BLOCK, a USE, an IDLE, and a TOGGLE are renewed and stored. Further, the following equation 3 can be obtained by means of the factors of table 2.
Scanning factor=alloc factor−toggle factor+block factor Equation 3

When the value of the scanning factor is high, this represents a group in which the number of assigned OVSF codes is large and the number of toggles is small.

—Ranking of a Group—

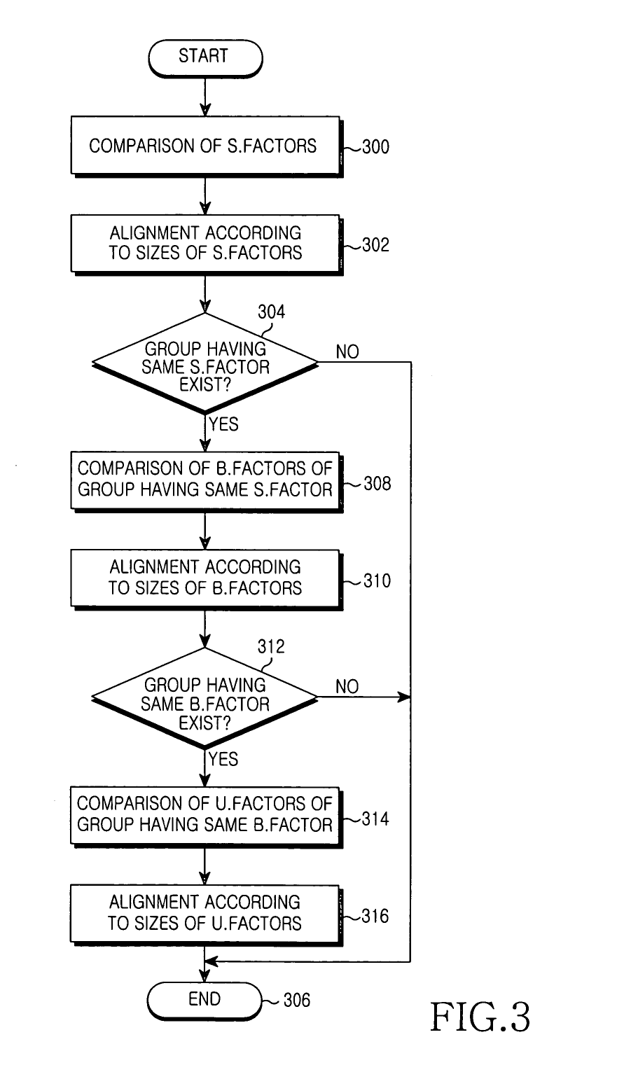

FIG. 3 is a flowdiagram illustrating a method according to the present invention, which determines a ranking of four groups by means of factors constituting the scanning factor.

In step 300, the scanning factors “S.factors” for a corresponding SF of each group are compared with each other. In FIG. 3, since an SF code tree is divided into four groups, the number of the “S.factors”, which become objects of comparison, is 4. In step 302, the four groups are aligned according to the sizes of the “S.factors” compared in step 300.

In step 304, it is determined whether or not groups having the same ‘S.factor’ among “S.factors” compared in step 300 exist. As a result of the determination, when there are no groups having the same ‘S.factor’, the procedure moves into step 306. In contrast, when there exist groups having the same ‘S.factor’, step 308 is performed. In step 308, block factors “B.factors” for the corresponding SF of the groups having the same ‘S.factor’ are compared with each other. The number of the “B.factors”, which become objects of comparison, is 2 to 4.

In step 310, the groups having the same ‘S.factor’ are aligned according to the sizes of the “B.factors” compared in step 308. In step 312, it is determined whether or not groups having the same ‘B.factor’ among “B.factors” compared in step 308 exist. As a result of the determination, when there are no groups having the same ‘B.factor’, the procedure moves into step 306. In contrast, when there exist groups having the same ‘B.factor’, step 314 is performed.

In step 314, user factors ‘U.factors’ for the corresponding SF of the groups having the same ‘B.factor’ are compared with each other. In step 316, the groups having the same ‘B.factor’ are aligned according to the sizes of the ‘U.factors’ compared in step 314. Then, the procedure moves into step 306 and is ended. The four groups are realigned by a predetermined rule by performing the procedure of FIG. 3. A group having the largest ‘S.factor’ has a relatively small toggle and represents a group having many blocks and uses, that is, a relatively high degree of density. In contrast, a group having the smallest ‘S.factor’ has a relatively large toggle and represents a group having small blocks and uses, that is, a relatively low degree of density.

—Realignment of an OVSF Code—

OVSF codes used in a group having the lowest degree of density from among the groups realigned by the procedure of FIG. 3 are realigned at OVSF codes having not been used in a group having the highest degree of density. When the number of OVSF codes used in the group having the lowest degree of density is larger than that of OVSF codes having not been in the group having the highest degree of density, OVSF Codes remaining after the realignment are realigned at OVSF codes having not been used in a group having the secondary degree of density.

—Embodiment—

Hereinafter, the present invention will be described by means of an embodiment. Table 3 shows an OVSF code of an SF64. In the case of the periodical relocation, an OVSF code relocation for the SF64 is performed by the preset period. In contrast, in the case of the automatic relocation, this is a case in which a toggling ratio measured in the SF64 is the highest.

TABLE 3

| | |
|---|---|
| first group | BU II II BU UU II UI UI |
| second group | UU II IU UU UU IU UI II |
| third group | UI UI BB II UU II BI UU |
| fourth group | UI IU UU II UU II II II |

The B represents a code in a Block state, the U represents a code in a USE state, and the I represents a code in an Idle state. Table 4 shows factors for relocation by means of table 3.

TABLE 4

| | alloc factor | toggle factor | block factor | S. factor |
|---|---|---|---|---|
| first group | 8 | 2 | 2 | 8 |
| second group | 9 | 3 | 0 | 6 |
| third group | 9 | 3 | 3 | 9 |
| fourth group | 6 | 2 | 0 | 4 |

In table 4, a group having the highest degree of density is the third group and a group having the lowest degree of density is the fourth group. Accordingly, OVSF codes assigned to the fourth group are relocated at OVSF codes assigned to the third group. That is, the U and B of the fourth group are relocated at the I of the third group. Table 5 shows a result obtained by relocating the OVSF codes assigned to the fourth group at the third group.

TABLE 5

| | |
|---|---|
| first group | BU II II BU UU II UI UI |
| second group | UU II IU UU UU IU UI II |
| third group | UU UU BB UU UU UU BI UU |
| fourth group | II II II II II II II II |

All OVSF codes assigned to the fourth group are always in an assignable state by performing the relocation process as shown in table 5.

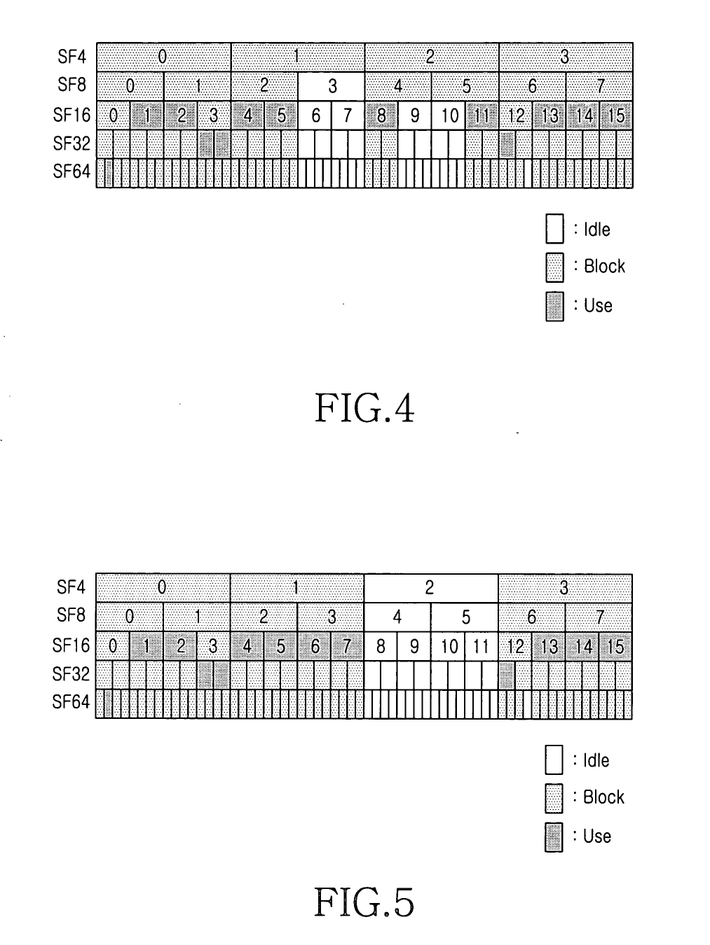

FIG. 4 is a view illustrating a condition for performing an automatic relocation process according to the present invention. Hereinafter, the condition for performing the automatic relocation process and a process by which factors for performing the automatic relocation are calculated will be described with reference to FIG. 4.

The SFs of the SF4 of FIG. 4 represent groups. When all SFs of the SF4 are being used or come into an unavailable state, the automatic relocation process is performed. Since the SFs of the SF4 are in an unavailable state in FIG. 4, a condition for performing the automatic relocation process is satisfied. When the condition for the automatic relocation is satisfied, SFs which are to perform the automatic relocation are determined. As described above, the SFs which are to perform the automatic relocation are determined by means of a toggling ratio. The toggle of the SF8 is one pair constructed by SF8,2 and SF8,3. Accordingly, a toggle for the SF8 is 1 and a toggling ratio is 25%. The toggle for the SF16 is one pair constructed by SF16,8 and SF16,9 and one pair constructed by SF16,10 and SF16,11. Accordingly, a toggle for the SF16 is 2 and a toggling ratio is 25%. There are no toggles for SF32 and SF64. Accordingly, one of the SF8 and the SF16 is selected and an OVSF code relocation process is performed for the selected one. However, in SF8, since all other codes except for the SF8,3 are in an unavailable state, it is meaningless to perform the code relocation process. Accordingly, a code relocation process is performed for the SF16. Table 6 shows factors for performing a code relocation for the SF16.

TABLE 6

| | alloc | | | |
|---|---|---|---|---|
| | factor | toggle factor | block factor | S. factor |
| first group (SF4, 0) | 4 | 0 | 2 | 6 |
| second group (SF4, 1) | 2 | 0 | 2 | 4 |
| third group (SF4, 2) | 2 | 2 | 2 | 2 |
| fourth group (SF4, 3) | 4 | 0 | 1 | 5 |

In Table 6, the first group has the highest degree of density, the fourth group has the secondary degree of density, the second group has the tertiary degree of density, and the third group has the lowest degree of density. Accordingly, the codes of the third group having the lowest degree of density must be relocated to the first group having the highest degree of density. However, as shown in FIG. 4, there exist no available codes in the first group and the fourth group of the SF16. Accordingly, the codes of the third group must be relocated to the second group. The SF16,8 is relocated to an SF16,6 and the SF16,11 is relocated to an SF16,7, or the SF16,8 is relocated to an SF16,7 and the SF16,11 is relocated to an SF16,6.

FIG. 5 is a view illustrating a result obtained by relocating FIG. 4 by the automatic relocation process. As shown in FIG. 5, the SF codes contained in the third group SF4,2 come into an assignable state through the automatic relocation process.

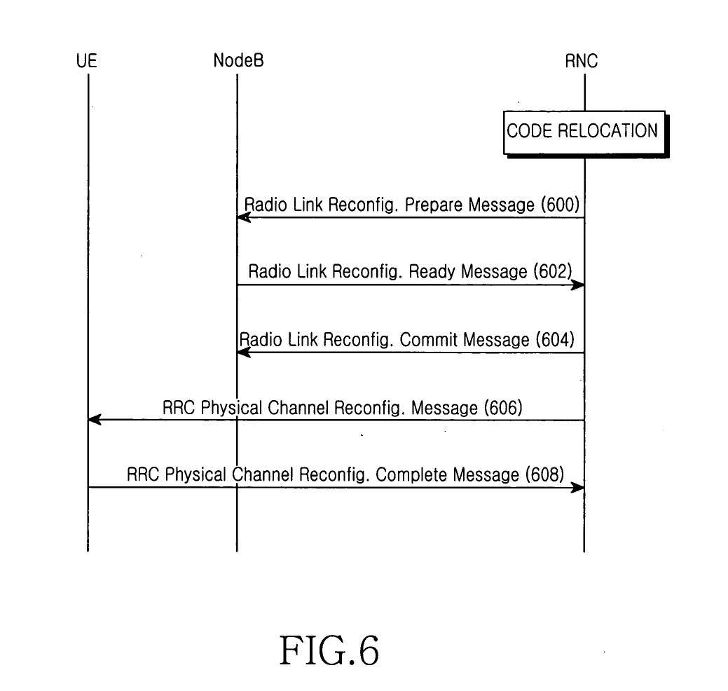

FIG. 6 is a flowdiagram illustrating a process by which an RNC notifies a node B and a UE of a result of an OVSF relocation according to the present invention. Hereinafter, a process by which the RNC notifies the node B and the UE of a relocated OVSF code according to the present invention will be described with reference to FIG. 6.

When an assigned OVSF code satisfies an automatic relocation condition or a relocation condition by a preset period, the RNC performs a relocation process. Detailed contents about the relocation process is as described above. When performing the relocation for the OVSF code, the RNC must notify the node B and the UE of a result obtained by performing the relocation. The node B and the UE renew OVSF codes being already used by means of the result of the relocation notified by the RNC.

In step 600, the RNC transmits a radio link reconfiguration prepare message to the node B. The RNC requests a radio link setting to the node B by the radio link reconfiguration prepare message. In step 602, the node B transmits a radio link reconfiguration ready message to the RNC. In step 604, the RNC transmits information on the renewed OVSF code to the node B. The node B having received the information on the renewed OVSF code sets a system by means of the received OVSF code again.

In step 606, the RNC transmits a RRC physical channel reconfiguration request message to a UE. In step 608, the UE transmits a RRC physical channel reconfiguration complete message which is a response message for the message in step 606. The RNC having received the RRC physical channel reconfiguration complete message transmits the information on the renewed OVSF code to the UE. The UE having received the information on the renewed OVSF code sets the system by means of the received OVSF code again.

In the present invention as described above, in order to effectively assign limited OVSF codes for downlink channelization, an OVSF code relocation process is performed according to predetermined time intervals or while satisfying a preset condition. The OVSF code relocation process is performed in this way, thereby minimizing the number of unavailable OVSF codes. Therefore, radio sources can be effectively used.

While the invention has been shown and described with reference to certain preferred embodiments thereof, it will be understood by those skilled in the art that various changes in form and details may be made therein without departing from the spirit and scope of the invention as defined by the appended claims.

1. A method for assigning orthogonal codes for channelization for data transmission by a radio network controller of a mobile communication system having an orthogonal code tree structure in which each of multiple upper codes having orthogonality between the upper codes is branched out into multiple lower codes which do not have orthogonality with respect to the upper codes, the method comprising the steps of:
a) confirming whether or not the lower codes derived from one upper code have different available states; and
b) reassigning the orthogonal codes for the data transmission so that the lower codes derived from one upper code have same available states, when there exist two or more lower codes having the different available states as a result of the confirmation.

2. The method as claimed in claim 1, wherein the different available states are classified into an unavailable state and an available state, the upper codes being in use or unavailable due to the upper code or the lower code in the unavailable state.

3. The method as claimed in claim 2, wherein the orthogonal code tree includes orthogonal codes having three or more spreading factors different from each other.

4. The method as claimed in claim 3, wherein, in step b), ratios of the different available states are measured in orthogonal codes having same spreading factors and then the orthogonal codes are reassigned by means of codes having a spreading factor including a highest measured ratio.

5. The method as claimed in claim 4, wherein a priority of the upper code is determined by means of the orthogonal codes having the spreading factor including the highest measured ratio.

6. The method as claimed in claim 5, wherein the priority is determined by comparing sizes shown in an equation below of the orthogonal codes having the spreading factor including the highest measured ratio contained in the upper code,
Scanning factor=alloc factor−toggle factor+block factor,
wherein:
the alloc factor represents a number of orthogonal codes which are being in use or unavailable due to the upper code or the lower code;
the toggle factor represents a number of orthogonal codes in which the lower codes derived from one upper code have different available states; and
the block factor represents a number of orthogonal codes having an unavailable state due to the upper code or the lower code.

7. The method as claimed in claim 6, wherein the block factor and the toggle factor are sequentially compared when the orthogonal codes having the spreading factor including the highest measured ratio have same values obtained by the equation in claim 6.

8. The method as claimed in claim 1, wherein, in step b), the orthogonal codes for the data transmission are reassigned when the multiple upper codes are being in use or come into unavailable states due to the upper code or the lower code.

9. The method as claimed in claim 1, wherein a time for reassigning the orthogonal codes for the data transmission is set according to each spreading factor and the orthogonal codes are reassigned when the set time passes.

10. An apparatus for assigning orthogonal codes for channelization for data transmission in a mobile communication system having an orthogonal code tree structure in which each of multiple upper codes having orthogonality between the upper codes is branched out into multiple lower codes which do not have orthogonality with respect to the upper codes, the apparatus comprising:
a radio network controller for confirming whether or not the lower codes derived from one upper code have different available states, and reassigning the orthogonal codes for the data transmission so that the lower codes derived from one upper code have same available states, when there exist two or more lower codes having the different available states as a result of the confirmation; and
a node B and a user equipment for setting a radio channel by means of the orthogonal codes assigned by the radio network controller and exchanging data through the set radio channel.

11. The apparatus as claimed in claim 10, wherein the different available states are classified into an unavailable state and an available state, the upper codes being in use or unavailable due to the upper code or the lower code in the unavailable state.

12. The apparatus as claimed in claim 11, wherein the orthogonal code tree includes orthogonal codes having three or more spreading factors different from each other.

13. The apparatus as claimed in claim 12, wherein the radio network controller measures ratios of the different available states in orthogonal codes having same spreading factors and then reassigns the orthogonal codes by means of codes having a spreading factor including a highest measured ratio.

14. The apparatus as claimed in claim 13, wherein the radio network controller determines a priority of the upper code by means of the orthogonal codes having the spreading factor including the highest measured ratio.

15. The apparatus as claimed in claim 14, wherein the priority is determined by comparing sizes shown in an equation below of the orthogonal codes having the spreading factor including the highest measured ratio contained in the upper code,
Scanning factor=alloc factor−toggle factor+block factor,
wherein:
the alloc factor represents a number of orthogonal codes which are being in use or unavailable due to the upper code or the lower code;
the toggle factor represents a number of orthogonal codes in which the lower codes derived from one upper code have different available states; and
the block factor represents a number of orthogonal codes having an unavailable state due to the upper code or the lower code.

16. The apparatus as claimed in claim 15, wherein the block factor and the toggle factor are sequentially compared when the orthogonal codes having the spreading factor including the highest measured ratio have same values obtained by the equation in claim 15.

17. The apparatus as claimed in claim 10, wherein the radio network controller reassigns the orthogonal codes for the data transmission when the multiple upper codes are being in use or come into unavailable states due to the upper code or the lower code.

18. The apparatus as claimed in claim 10, wherein the radio network controller sets a time for reassigning the orthogonal codes for the data transmission according to each spreading factor and reassigns the orthogonal codes when the set time passes.
